(19) United States
(12) Patent Application Publication
(10) Pub. No.: US 2017/0196383 A1
(43) Pub. Date: Jul. 13, 2017

(54) DOUBLED-LAYER DISPOSABLE CUP

(71) Applicant: TAJU SHOAGA, HOUSTON, TX (US)

(72) Inventor: TAJU SHOAGA, HOUSTON, TX (US)

(21) Appl. No.: 15/391,363

(22) Filed: Dec. 27, 2016

Related U.S. Application Data
(60) Provisional application No. 62/387,910, filed on Jan. 11, 2016.

(51) Int. Cl. A47G 19/22; G01K 13/00; B65D 81/38

(52) U.S. Cl. CPC A47G 19/2227; B65D 81/3869; B65D 81/3867; A47G 19/2288; G01K 13/00; A47G 2019/225

(57) ABSTRACT

A doubled-layer disposable cup assembly with air insulation comprises of two layered-cups one inside the other. Each layer has a truncated conical side wall with an outwardly joined rim at the top ends and a bottom wall at the smaller end. The outwardly joined rim of the inner layer maintains an air space between the side walls of the two layers. The contacts at the bottom and top provide support for the inner layer and maintain it in axial alignment with the outer layer. The contact pressure between the rim of the inner layer and the side wall of the outer layer essentially seals the air space for a more efficient air insulation and also provides a force that keeps the inner layer and the outer layer together.

### BACKGROUND OF THE INVENTION

1. Field of the Invention

This invention generally relates to disposable Styrofoam cup for hot or cold liquids, and more particularly to doubled-layer air insulation disposable Styrofoam cup.

2. Description of the Prior Art

Different cup assemblies have been devised to take advantage of air as an insulating medium for disposable cups. These assemblies are generally inefficient or have high manufacturing cost or material consumption. The high cost of manufacturing is due to the requirement of special machinery and extra procedures for assembling. Besides, some of the assemblies have their own limitations too.

Paper-based materials are generally favored for disposable cups, because of low cost and high volume production capability. However, paper-based materials generally do not have good barrier properties to liquids. Disposable cups made from such paper-based materials, have a tendency to decompose due to liquid penetration into the paper material, which can cause the cup to lose its structure and become soggy or leak. Furthermore, cups made from paper-based materials generally do not provide adequate air insulation.

There have been many attempts to provide improved thermal insulation to paper-based disposable cups, U.S. Pat. No. 5,226,585 to Varano discloses a double-walled disposable cup made from paper-based materials, which has a smooth walled inner cup and an outer wrap with inwardly directed ribs being useful to maintain a gap between the walls to provide thermal insulation. However, these cups are difficult and expensive to manufacture. They also tend to exhibit liquid barrier problems, which compromise the structural integrity of the cup.

U.S. Pat. No. 5,385,260 by Gatcomb discloses a paper sleeve with longitudinal indentations. The sleeve is manufactured with a cup using adhesives. Since paper cannot tolerate deep indentation there is not enough separation between the sleeve and the cup for efficient insulation. Besides, the sleeve does not have the preferred smooth surface of a regular cup for appearance and displaying printed information clearly.

U.S. Pat. No. 3,908,523 by Shikaya discloses a corrugated sleeve. This design provides a better protection for the hand but it uses excessive material and is not suitable for displaying printed information.

U.S. Pat. No. 5,145,107 by Silver et al discloses a double walled cup. The two walls approach each other towards the 45 mouth of the cup where they come in contact. Although the invention uses smooth paper without any spacer between the walls, it requires especial machinery.

The design is inefficient because it fails to provide an optimum air layer along the height of the cup. Besides, the cup still becomes hot near the top and uncomfortable to hold while for stability a cup should be held near the top.

Accordingly, there is a need for a doubled-layer disposable cup that provides excellent air insulation and barrier properties and is recyclable.

### SUMMARY OF THE INVENTION

The present invention relates to a doubled-layer air insulation disposable cup made from Styrofoam materials useful for containing hot and cold substances. The doubled-layer air insulation disposable cup in accordance with the invention provide recyclability, enhanced container structural integrity and improved insulation. The manufacturing of the cups are also cost effective.

In a preferred embodiment of the present invention, the cup assembly comprised of two layers Styrofoam cups. An outer layer has a truncated conical side wall outwardly joined at the rim of the inner layer and a bottom wall of the inner layer. The inner layer is smaller than the outer layer. The relative dimensions of the two layers are such that the bottom end of the inner layer touches the bottom wall of the outer layer. The attachment of the inner cup and the outer layer maintains an air space between the side walls of the two layers. The contacts at the bottom and top provide support for the inner layer and maintain it in axial alignment with the outer layer. The contact pressure between the larger end of the inner cup and the side wall of the outer cup essentially seals the air space for more efficient air insulation.

In another preferred embodiment of the present invention, the outer layer comprises of two air holes having punch covers. While these covers remain close when the cup is used for hot liquids, they are opened for air circulation to eliminate humidity when the cup is used for cold liquids, and keeps the liquids cold for a longer period of time.

It is an object of the present invention is to provide a disposable cup assembly with efficient air insulation that is cost effective and can be manufactured easily. The cup assembly comprises of two separate cups that can be manufactured by existing standard equipment for low cost, easy, and fast production and assembly.

It is another object of the present invention is to provide a series of small, medium, large, and extra large size of regular cups with such a dimensional relation that the medium cup can be used as the outer cup for the small cup, the large cup can be used as the outer cup for the medium cup, and the extra large cup can be used as the outer cup for the large cup.

Still another object of the present invention is to providing an air layer around the inner cup for efficient insulation and hand protection along essentially all its height from bottom to top.

Further objects and advantages of the present invention will become apparent by reference to the following detailed disclosure of the invention and appended drawings wherein like reference numerals refer to the same feature, component or element.

### BRIEF DESCRIPTION OF DRAWINGS

FIG. 1 is a perspective view of a doubled-layer air insulation disposable cup according to the present invention.

FIG. 2 is a front view of the doubled-layer air insulation disposable cup showing an air hole having punch cover according to the present invention.

FIG. 3 is a sectional view of the doubled-layer air insulation disposable cup showing an air space for air insulation according to the present invention.

FIG. 4 is a side view of the doubled-layer air insulation disposable cup showing a temperature sensor measurement according to the present invention.

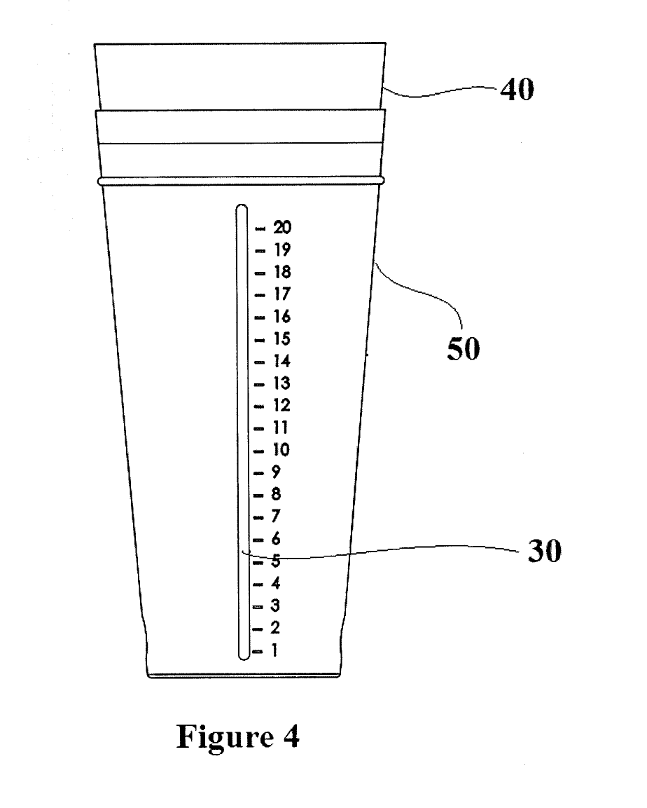

### DETAILED DESCRIPTION OF THE INVENTION

The present invention provides a doubled-layer disposable cup having excellent air insulation properties and recyclability. As used herein the term “disposable” means to describe articles that are most often discarded after one use, “doubled-layer” refers to a structure that includes an inner layer, an outer layer, and a space defined between the inner layer and outer layer, and “air insulation” refers generally to the prevention of heat transferred in and out from the inner layer for preserving the temperature of the cup contents.

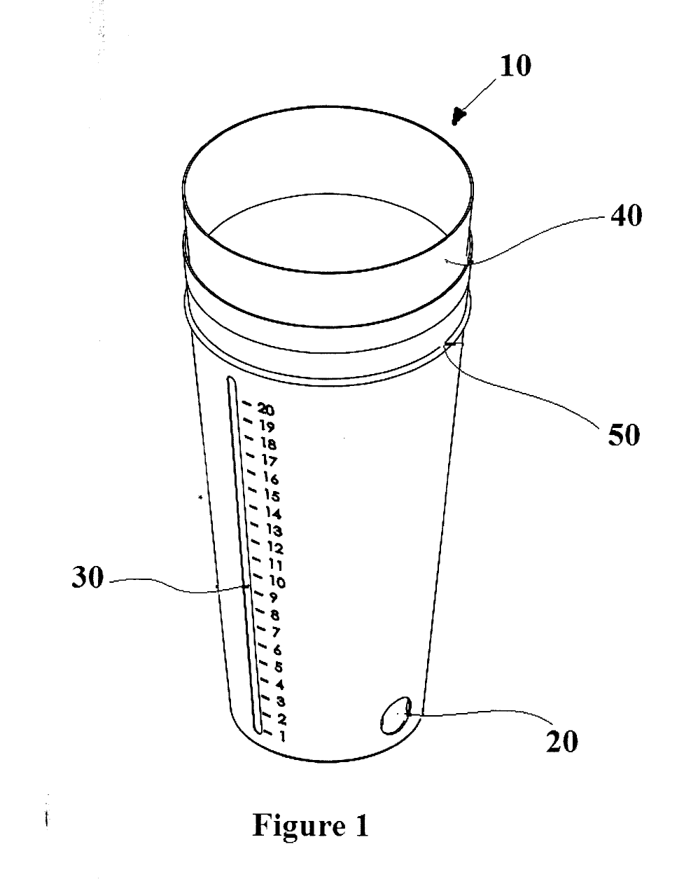

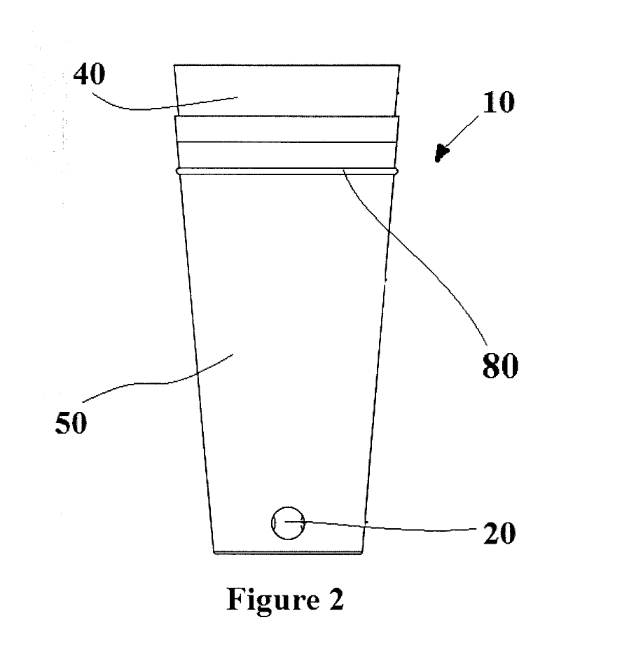

Referred to FIG. 1, a cup assembly 10 comprises of an outer layer 50 and an inner layer 40, wherein the inner layer 40 is a regular cup and has a truncated conical shape with side wall 60 as shown in FIG. 2.

Still referring FIG. 1, the cup assembly 10 further comprises of a temperature sensor measurement 30 indicating whether the substances contained is hot or cold.

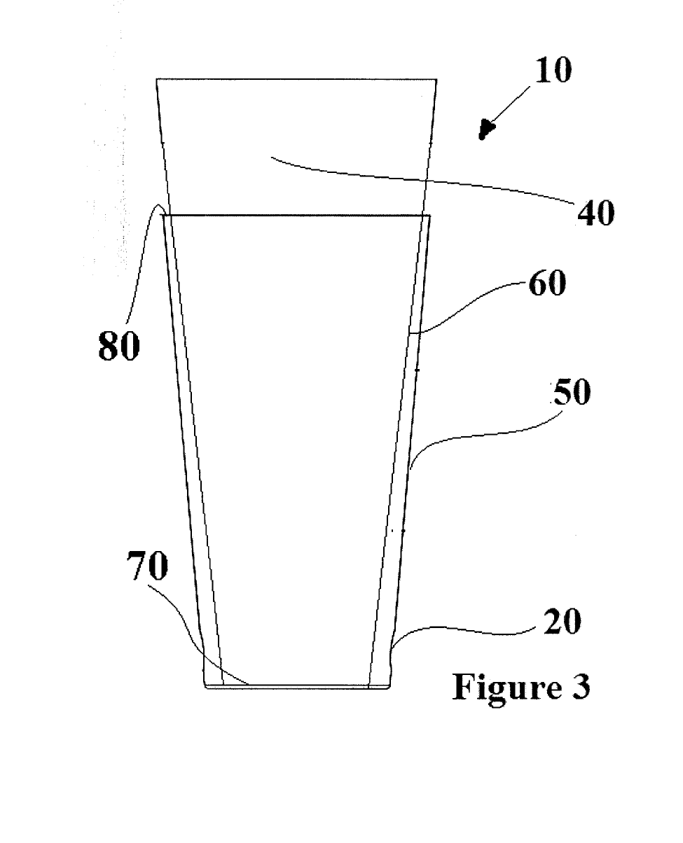

Referring now FIG. 3, the bottom end of inner layer 40 and outer layer 50 is closed and sealed by bottom wall 70. Outer layer 50 is a regular cup and has a truncated conical shape with top end 80 sealed by side wall 60 of the inner layer 40. The bottom end of inner layer 40 is closed and sealed by bottom wall 70 of the outer layer 50. The cone angle of outer layer 50 is preferably equal to or less than that of inner layer 40.

Still referring FIG. 3, two air holes 20 with punch covers located near the bottom wall 70 of the outer layer 50 are shown. These air holes having diameters about of 2-3 centimeters allows fresh air circulation to eliminate humidity, therefore preserves the temperature of the liquids contained inside the inner layer 40.

In one embodiment of the invention, the inner layer 40 and outer layer 50 may be formed parallel to each other or any suitable design. In an embodiment of the invention, a horizontal rib 80 is welded on the outer layer 50 for additional strength as shown in FIG. 3.

The inner layer 40 and outer layer 50 may be formed of any suitable disposable materials, preferably Styrofoam.

In accordance with an embodiment of the invention, preferably, the inner layer 40 and outer layer 50 are preferably of from about 2 mm to 4 mm in thickness and more preferably of from about 2 mm to 3 mm in thickness.

In one embodiment of the invention, the container 100 is transparent. In this embodiment it is preferred that at least the inside wall or cup 102 and the outside wall or cup 104 are transparent. The inside wall or cup 102 and the outside wall or cup 104 are preferably formed from any suitable food grade plastic having transparent properties and a transparency value of 80 to 100%. While it is to be understood that the base section 108 also may be transparent, it is not required by the invention.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above described exemplary embodiments, but should be defined only in accordance with the following claims appended hereto and their equivalents.

Having illustrated and described the principles of the present invention in a preferred embodiment, it will be apparent to those skilled in the art that the embodiment can be modified in arrangement and detail without departing from such principles. Any and all such embodiments are intended to be included within the scope of the following claims.

What is claimed is:

1. A doubled-layer disposable cup assembly with air insulation, comprising:
(a) an inner layer to receive the liquids, wherein the inner layer has a side wall and a bottom wall, and wherein the side wall is a truncated cone with inside and outside surfaces and circular top and bottom end;
(b) an outer layer, wherein the outer layer has a side wall and a bottom wall, wherein the side wall is a truncated cone with inside and outside surfaces and circular top and bottom end.

2. The cup assembly of claim 1, wherein the inner and the outer layer are joined at the circular top and the bottom end of the inner layer.

3. The cup assembly of claim 2, wherein the join maintains and seals an air space between the side walls of the inner layer and the outer layer for efficient air insulation.

4. The cup assembly of claim 1, wherein the top end is larger than the bottom end.

5. The cup assembly of claim 1, wherein the bottom end of the inner layer is closed and sealed with the bottom end of the outer layer.

6. The cup assembly of claim 1, wherein the inner cup is the smaller size than the outer layer.

7. The cup assembly of claim 1, wherein the side wall of the inner layer comprises at least two air holes having punch covers for maintaining the temperature of the liquids.

8. The cup assembly of claim 7, wherein the punch covers are opened for cold liquids.

9. The cup assembly of claim 1, wherein there is an air space between the bottom walls of the inner cup and the outer cup.

10. The cup of claim 1, wherein the inner layer having a thickness of from about 2 to about 4 mm, preferably of from 2 mm to 3 mm.

11. The cup of claim 1, wherein the outer layer having a thickness of from about 2 to about 4 mm, preferably of from 2 mm to 3 mm.

12. The doubled-layer disposable cup of claim 1, wherein the air insulation is between inner cup and outer cup.

13. The doubled-layer disposable cup of claim 1, wherein the outer layer comprises a thermometer.
